(19) United States
(12) Patent Application Publication
(10) Pub. No.: US 2019/0214186 A1
(43) Pub. Date: Jul. 11, 2019

(54) COIL, REACTOR, AND COIL DESIGN METHOD

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka (JP)

(72) Inventor: Kazuhiro Inaba, Yokkaichi, Mie (JP)

(21) Appl. No.: 16/334,264

(22) PCT Filed: Sep. 5, 2017
(86) PCT No.: PCT/JP2017/031941

§ 371 Date: Mar. 18, 2019

(30) Foreign Application Priority Data
Sep. 21, 2016 (JP) 2016-184832

(51) Int. Cl. H01F 27/28; H01F 27/24

(52) U.S. Cl. CPC H01F 27/2823; H01F 27/24

(57) ABSTRACT

A coil includes a first wound portion that is formed by helically winding a first wire and a second wound portion that is formed by helically winding a second wire electrically connected to the first wound portion and has an axis that is parallel to an axis of the first wound portion. The first wire has a larger cross-sectional area than the second wire, and the first wound portion has a smaller number of turns than the second wound portion.

### CROSS-REFERENCE TO RELATED APPLICATIONS

This application is the U.S. national stage of PCT/JP2017/031941 filed Sep. 5, 2017, which claims priority of Japanese Patent Application No. JP 2016-184832 filed Sep. 21, 2016, the contents of which are incorporated herein.

### TECHNICAL FIELD

The present disclosure relates to a coil, a reactor, and a coil design method.

### BACKGROUND

One of the components of a circuit that increases and decreases the voltage is a reactor. For example, a reactor disclosed in JP 2014-146656A includes a coil having a pair of coil elements (wound portions) and a ring-shaped magnetic core that is combined with the coil. The coil elements are wound the same number of turns and arranged side-by-side in parallel so that their axial directions are parallel to each other (0020 of the specification and FIG. 1).

Due to restrictions related to the installation of the reactor, and the like, there is room for further improvement in heat generation characteristics of the pair of wound portions.

### SUMMARY

A coil according to the present disclosure includes a first wound portion that is formed by helically winding a first wire; and a second wound portion that is formed by helically winding a second wire electrically connected to the first wound portion and has an axis that is parallel to an axis of the first wound portion. The first wire has a larger cross-sectional area than the second wire, and the first wound portion has a smaller number of turns than the second wound portion.

A reactor according to the present disclosure is a reactor including: a coil and a magnetic core on which the coil is disposed. The coil is the above-described coil according to the present disclosure.

A coil design method according to the present disclosure includes: a temperature acquisition step of obtaining, under a predetermined current-flowing condition, the maximum temperatures of wound portions of coils. The coils each include a first wound portion that is formed by helically winding a first wire and a second wound portion that is formed by helically winding a second wire electrically connected to the first wound portion and has an axis that is parallel to an axis of the first wound portion. The wires of the coils having different cross-sectional areas and the wound portions of the coils having different numbers of turns, with a total number of turns of each coil being fixed. A selection step of selecting the cross-sectional areas of the respective wires and the numbers of turns of the respective wound portions when a higher maximum temperature of the maximum temperatures of the two wound portions is the lowest.

Thus, an object of the present disclosure is to provide a coil in which a pair of wound portions satisfies a specific relationship with respect to heat generation characteristics.

Another object of the present disclosure is to provide a reactor equipped with the above-described coil.

Yet another object of the present disclosure is to provide a coil design method for designing the above-described coil.

### Advantageous Effects of the Present Disclosure

In the coil of the present disclosure, the pair of wound portions satisfies a specific relationship with respect to heat generation characteristics.

The reactor of the present disclosure is low-loss.

The coil design method of the present disclosure makes it possible to design a coil in which a pair of wound portions satisfies a specific relationship with respect to heat generation characteristics.

### BRIEF DESCRIPTION OF DRAWINGS

FIG. 1 is an overall perspective view schematically showing a reactor according to Embodiment 1.

FIG. 2 is a top view schematically showing the reactor according to Embodiment 1.

FIG. 3 is a graph showing the maximum temperatures of wound portions under a continuous current-flowing condition of Test Example 1.

FIG. 4 is a graph showing the maximum temperatures of the wound portions under a transient-current current-flowing condition of Test Example 1.

### DETAILED DESCRIPTION OF PREFERRED EMBODIMENTS

Since wires of a pair of wound portions included in a conventional coil have the same cross-sectional area and are wound the same number of turns, if the wound portions are cooled by a cooling member with substantially balanced cooling performance, the wound portions are uniformly cooled. However, due to restrictions related to the placement of a reactor, and the like, there is a risk that the reactor will be cooled by a cooling member (e.g., cooling base etc.) whose cooling performance is unbalanced such that one of the wound portions is less well cooled than the other wound portion. In that case, the temperature of one of the wound portions will become higher than that of the other wound portion, leading to an increase in the loss of the reactor.

The inventor of the present disclosure considered that in order to evenly cool a pair of wound portions in the case where the wound portions are cooled by a cooling member with unbalanced cooling performance, it may be sufficient that a specific relationship with respect to heat generation characteristics in which one of the wound portions generates less heat than the other wound portion is satisfied, and conducted in-depth research on making the two wound portions have different heat generation characteristics. As a result, it was found that the two wound portions can be made to have different heat generation characteristics by making wires constituting the respective wound portions have different cross-sectional areas and the wound portions have different numbers of turns. In that case, the pair of wound portions can be evenly cooled by disposing one of the wound portions, which has the higher heat generation characteristics, on the higher cooling performance side and the other wound portion, which has the lower heat generation characteristics, on the lower cooling performance side. The present disclosure was achieved based on these findings. Aspects of the present disclosure will be listed and described first below.

A coil according to an embodiment of the present disclosure includes a first wound portion that is formed by helically winding a first wire; and a second wound portion that is formed by helically winding a second wire electrically connected to the first wound portion and has an axis that is parallel to an axis of the first wound portion. The first wire has a larger cross-sectional area than the second wire, and the first wound portion has a smaller number of turns than the second wound portion.

With this configuration, when the first wound portion and the second wound portion are compared with each other, a specific relationship with respect to heat generation characteristics in which the first wound portion generates less heat and the second wound portion generates more heat is satisfied. Therefore, the coil can be suitably used for a reactor that is cooled by a cooling member with unbalanced cooling performance. The reason for this is that when the first wound portion is disposed on the lower cooling performance side of the cooling member and the second wound portion is disposed on the higher cooling performance side of the cooling member, the first wound portion and the second wound portion can be evenly cooled, and the maximum temperature of the coil can be reduced. In this manner, the maximum temperature of the coil can be reduced, and therefore, a low-loss reactor can be constructed.

As an embodiment of the above-described coil, it is possible that the difference between the length of the first wound portion in an axial direction thereof and the length of the second wound portion in an axial direction thereof is 5% or less of the length of the first wound portion in the axial direction.

With this configuration, since the difference between the lengths of the first wound portion and the second wound portion in their axial directions is small, if the lengths of the first wound portion and the second wound portion in their axial directions are made substantially the same as the lengths of a pair of inner core portions on which the first wound portion and the second wound portion are respectively disposed, of a magnetic core, a reactor with little dead space is easily constructed.

As an embodiment of the above-described coil, it is possible that the difference between the number of turns of the first wound portion and the number of turns of the second wound portion is 10 or less.

With this configuration, since the difference between the numbers of turns of the first wound portion and the second wound portion is small, the cross-sectional area of the first wire is prevented from being excessively larger than the cross-sectional area of the second wire, and the number of turns of the first wound portion is prevented from being excessively smaller than the number of turns of the second wound portion. Therefore, the ease of winding is unlikely to vary between the first wound portion and the second wound portion.

As an embodiment of the above-described coil, it is possible that conductor wires of the first wire and the second wire are rectangular wires, the first wire and the second wire have the same width, and the first wire and the second wire have different thicknesses.

With this configuration, since the conductor wires are rectangular wires, and the wires have the same width, when this coil is combined with a pair of inner core portions, a reactor with little variation in width and height between the first wound portion and the second wound portion can be constructed.

A reactor according to an embodiment of the present disclosure is a reactor including: a coil; and a magnetic core on which the coil is disposed, wherein the coil is the coil according to any one of the above-described configurations.

With this configuration, the loss can be reduced. The reason for this is that since the reactor includes the coil having the first wound portion that generates less heat and the second wound portion that generates more heat, even when the cooling performance of the cooling member for cooling the coil is unbalanced, the first wound portion and the second wound portion can be uniformly cooled by disposing the first wound portion on the lower cooling performance side and disposing the second wound portion on the higher cooling performance side, and the maximum temperature of the coil can be reduced. Moreover, since the maximum temperature of the coil can be reduced, the material of a peripheral member of the coil can be selected from a wider range of alternatives.

A coil design method according to the present disclosure includes a temperature acquisition step of obtaining, under a predetermined current-flowing condition, the maximum temperatures of wound portions of coils. The coils each include a first wound portion that is formed by helically winding a first wire and a second wound portion that is formed by helically winding a second wire electrically connected to the first wound portion and has an axis that is parallel to an axis of the first wound portion, the wires of the coils having different cross-sectional areas and the wound portions of the coils having different numbers of turns, with a total number of turns of each coil being fixed.

A selection step of selecting the cross-sectional areas of the respective wires and the numbers of turns of the respective wound portions when a higher maximum temperature of the maximum temperatures of the two wound portions is the lowest.

With this configuration, a coil can be designed in which a first wound portion and a second wound portion satisfy a specific relationship with respect to heat generation characteristics.

Hereinafter, details of an embodiment of the present disclosure will be described with reference to the drawings. In the drawings, like reference numerals denote objects having like names. In the following embodiment, a coil, a coil design method, and a reactor will be described in that order.

### Embodiment 1

### Coil

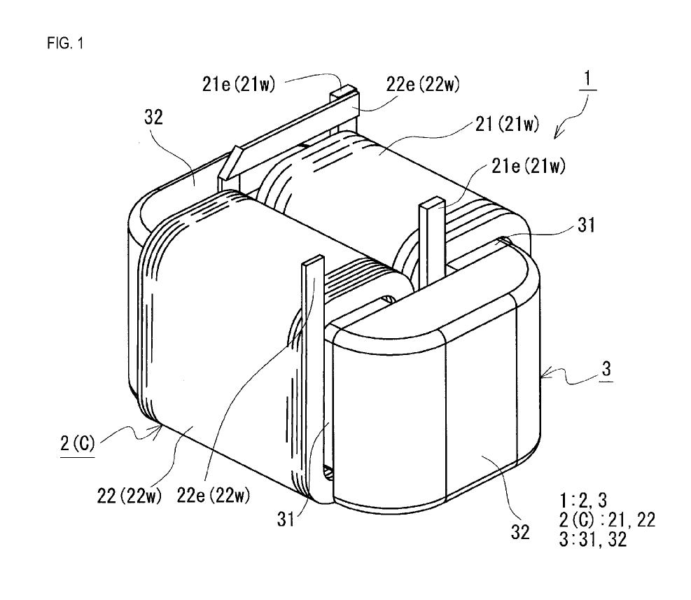

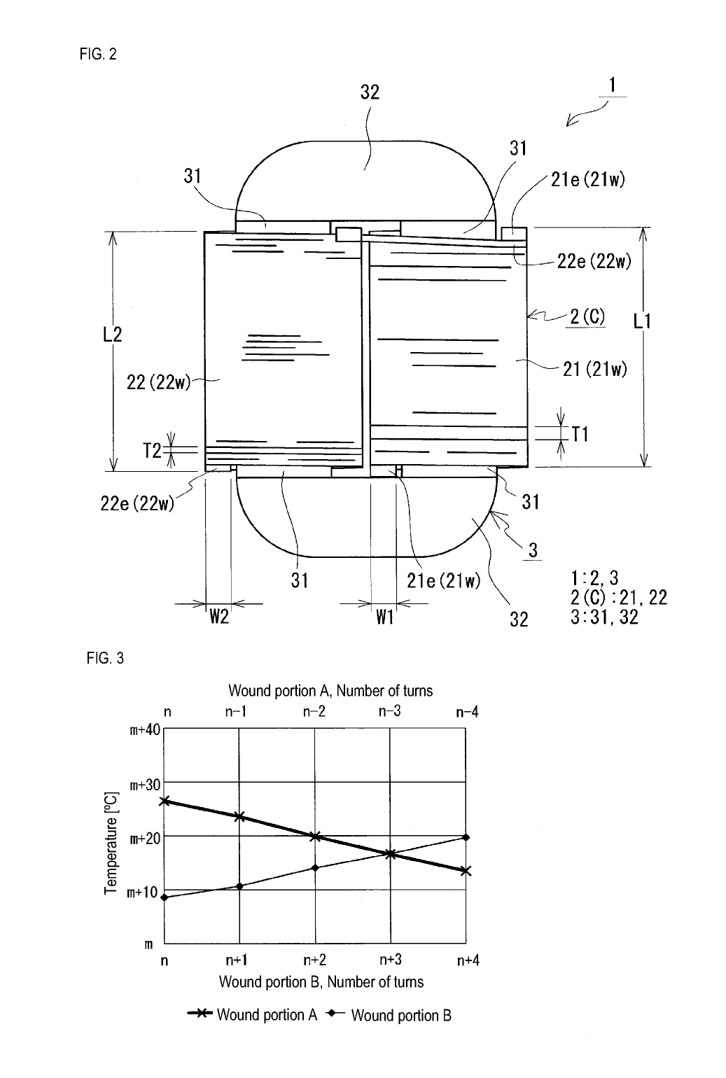

A coil C according to Embodiment 1 will be described with reference to FIGS. 1 and 2. The coil C includes a pair of wound portions 21 and 22. The coil C constitutes a coil 2 that is typically disposed on an outer periphery of a magnetic core 3 (inner core portions 31) included in a reactor 1, which will be described later (FIG. 1). One of the features of the coil C is that wires 21w and 22w of the respective wound portions 21 and 22 have different cross-sectional areas, and the wound portions 21 and 22 have different numbers of turns. Here, assuming that the reactor 1 is constructed by attaching the coil 2 to the magnetic core 3 and the reactor 1 is installed on an object, the object side will be described as the lower side, and the side opposite to the object as the upper side. In FIGS. 1 and 2, the thicknesses of the two wires 21w and 22w are shown in an exaggerated manner for convenience of description.

### First Wound Portion•Second Wound Portion

The first wound portion 21 is a hollow tubular body formed by helically winding the first wire 21w. The second wound portion 22 is a hollow tubular body formed by helically winding the second wire 22w. The first wound portion 21 and the second wound portion 22 are electrically connected to each other. The two wound portions 21 and 22 are arranged side-by-side (in parallel) so that their axial directions are parallel to each other. The shape of end surfaces of the wound portions 21 and 22 can be appropriately selected, and the end surfaces here are rectangular frame-shaped with rounded corners. Coated wires each including a conductor wire and an insulating coating made of an enamel (typically, polyamideimide) or the like and disposed on an outer periphery of the conductor wire can be used as the first wire 21w and the second wire 22w. The conductor wire may be a rectangular wire or a round wire made of a conductive material, such as copper, aluminum, or an alloy thereof. Here, coated rectangular wires are used as the two wires 21w and 22w, and the wound portions 21 and 22 are edgewise coils formed by winding the coated rectangular wires edgewise.

### Number of Turns

With regard to the numbers of turns of the respective wound portions 21 and 22, any numbers of turns that satisfy a relationship “(number of turns of first wound portion 21)<(number of turns of second wound portion 22)” can be appropriately selected depending on the desired inductance. Since the number of turns of the first wound portion 21 is smaller than the number of turns of the second wound portion 22, the length of the first wire 21w can be made shorter than the length of the second wire 22w. Therefore, when the total number of turns of the two wound portions 21 and 22 is fixed, the electrical resistance of the first wire 21w can be made lower than the electrical resistance of the second wire 22w, and heat generation by the first wire 21w (first wound portion 21) is more easily suppressed. Accordingly, if the second wound portion 22 that generates more heat than the first wound portion 21 is disposed on a higher cooling performance side of a cooling member (not shown) for cooling the coil C, the loss of the coil C is easily reduced. That is to say, a low-loss reactor 1 is easily constructed using this coil C. The total number of turns of the two wound portions 21 and 22 is appropriately selected depending on the desired inductance.

The difference between the number of turns of the first wound portion 21 and the number of turns of the second wound portion 22 can be determined using a coil design method, which will be described later. The difference between the number of turns of the first wound portion 21 and the number of turns of the second wound portion 22 can be set to be 10 or less, for example, although it depends on the current-flowing condition of the coil C and the difference between the cooling performance for the wound portion 21 and the cooling performance for the wound portion 22 of the cooling member for cooling the coil C. The difference in the number of turns can be set to be 2 or more.

### Length

The lengths (hereinafter referred to simply as axial lengths) L1 and L2 of the respective wound portions 21 and 22 in their axial directions can be appropriately selected depending on the desired inductance. Preferably, the axial length L1 of the first wound portion 21 and the axial length L2 of the second wound portion 22 are substantially the same (FIG. 2). “The axial length L1 of the first wound portion 21 and the axial length L2 of the second wound portion 22 being substantially equal to each other” means that the difference between the axial length L1 of the first wound portion 21 and the axial length L2 of the second wound portion 22 is 5% or less of the axial length L1 of the first wound portion 21. In that case, if the axial lengths L1 and L2 of the respective wound portions 21 and 22 are substantially the same as the lengths in the axial directions of the inner core portions 31 on which the respective wound portions 21 and 22 are disposed, a reactor 1 with little, or substantially no, dead space can be constructed, and therefore the size of the reactor 1 can be reduced.

### Cross-Sectional Area

The cross-sectional areas of the respective wires 21w and 22w satisfy a relationship “(cross-sectional area of first wire 21w)>(cross-sectional area of second wire 22w)”. Since the cross-sectional area of the first wire 21w is larger than the cross-sectional area of the second wire 22w, the electrical resistance of the first wire 21w can be made lower than the electrical resistance of the second wire 22w. Accordingly, if the second wound portion 22, which generates more heat than the first wound portion 21, is disposed on the higher cooling performance side of the cooling member, a low-loss reactor 1 is easily constructed. The cross-sectional areas of the respective wires 21w and 22w, that is, the difference between the cross-sectional area of the first wire 21w and the cross-sectional area of the second wire 22w can be appropriately selected depending on the numbers of turns and the axial lengths L1 and L2 of the wound portions 21 and 22.

### Size

It is preferable that the sizes of the respective wires 21w and 22w satisfy a relationship “(width W1 of first wire 21w)=(width W2 of second wire 22w)” and also satisfy a relationship “(thickness T1 of first wire 21w)>(thickness T2 of second wire 22w)” (FIG. 2). The widths W1 and W2 refer to the lengths in a direction in which the wound portions 21 and 22 are arranged in parallel, and the thicknesses T1 and T2 refer to the lengths in the axial directions of the respective wound portions 21 and 22. “The width W1 of the first wire 21w and the width W2 of the second wire 22w being equal to each other” means such an extent that when the reactor 1 is constructed by combining the coil C with the magnetic core 3, no variations in width and height occur between the first wound portion 21 and the second wound portion 22. The difference between the thickness T1 of the first wire 21w and the thickness T2 of the second wire 22w can be appropriately selected depending on the numbers of turns and the axial lengths L1 and L2 of the wound portions 21 and 22.

### End Portions

End portions 21e and 22e on one end side (right side on the paper plane of FIG. 1) of the respective wound portions 21 and 22 in their axial directions are extended upward. The insulating coating of a leading end of each of these end portions is removed to expose the conductor, and a terminal member (not shown) is connected to the exposed conductor. An external device (not shown) such as a power supply that supplies power to the coil C is connected to the coil C via the terminal member. On the other hand, end portions 21e and 22e on the other end side (left side on the paper plane of FIG. 1) of the wound portions 21 and 22 in their axial directions are electrically connected to each other. The end portions 21e and 22e may be electrically connected to each other by directly connecting these end portions to each other, or by connecting these end portions via a connecting member independent of the first wound portion 21 and the second wound portion 22.

In the case where the end portions 21e and 22e are directly connected to each other, a configuration is conceivable in which the end portion 22e side of the second wire 22w of the second wound portion 22 is bent and extended toward the end portion 21e of the first wire 21w of the first wound portion 21, and thereby the two end portions 21e and 22e are connected to each other. Although the first wire 21w may be bent instead of the second wire 22w, the second wire 22w is easier to bend than the first wire 21w because the cross-sectional area of the second wire 22w is smaller than the cross-sectional area of the first wire 21w.

With regard to the method for bending the end portion 22e side of the second wire 22w, a method may be adopted in which the end portion 22e side of the second wire 22w is folded back as shown in FIG. 1, and in the folded-back portion, portions of the wire are laid one on top of the other in the thickness direction such that the extending direction of the wire 22w is changed by 90°, or a method may be adopted in which the end portion 22e side of the second wire 22w is bent edgewise like turn-forming portions. On the other hand, in the case where the end portions 21e and 22e are connected to each other via the aforementioned connecting member, it is conceivable to use the same wire material as that of the first wire 21w or the second wire 22w as the connecting member. The end portions 21e and 22e can be connected to each other, and the end portions 21e and 22e can be connected to the connecting member, through welding (e.g., TIG welding).

### Others

A wire that has a thermally fusion-bondable layer composed of a thermally fusion-bondable resin can be used as each of the wires 21w and 22w. In this case, after the wires 21w and 22w are appropriately wound, the wound wires are heated at an appropriate timing to melt the thermally fusion-bondable layers, and adjacent turns of the wound wires are joined to each other by the thermally fusion-bondable resins. In the thus obtained coil C, since thermally fusion-bondable resin portions are present between the turns, the turns do not substantially offset from each other, and therefore the coil C is unlikely to deform. Examples of the thermally fusion-bondable resins that compose the thermally fusion-bondable layers include thermosetting resins, such as epoxy resins, silicone resins, and unsaturated polyesters.

### Effects of the Coil

With the above-described coil C, the specific relationship with respect to heat generation characteristics, in which the first wound portion 21 generates less heat and the second wound portion 22 generates more heat, is satisfied. Therefore, the coil C can be suitably used for a reactor that is cooled by a cooling member with unbalanced cooling performance.

### Coil Design Method

The numbers of turns of the respective wound portions 21 and 22 of the coil C can be determined using a coil design method including a temperature acquisition step and a selection step.

### Temperature Acquisition Step

In the temperature acquisition step, the maximum temperatures of the respective wound portions under a predetermined current-flowing condition are obtained. At this time, a plurality of types of coils are prepared in which wires have different cross-sectional areas and wound portions have different numbers of turns. However, the total number of turns of the two wound portions of each type of coil is fixed. Then, the plurality of types of coils are combined with respective magnetic cores to produce reactors, and the maximum temperatures of the wound portions are obtained by letting current flow through the coils. With regard to the predetermined current-flowing condition, a current-flowing condition suited to a use situation of the coils can be appropriately selected. The maximum temperatures of the wound portions may be obtained through actual measurement or using a piece of commercially-available simulation software.

For example, a plurality of types (the following three types) of coils in each of which the total number of turns of the two wound portions is 2n are prepared.
Coil n₁: The number of turns of a wound portion A₁ is n−1, and the number of turns of a wound portion B₁ is n+1.
Coil n₂: The number of turns of a wound portion A₂ is n−2, and the number of turns of a wound portion B₂ is n+2.
Coil n₃: The number of turns of a wound portion A₃ is n−3, and the number of turns of a wound portion B₃ is n+3.

In the coil n₁, the number of turns of the wound portion A₁<the number of turns of the wound portion B₁, and the difference between the numbers of turns of the two wound portions is 2. Similarly, the difference between the numbers of turns of the two wound portions of the coil n₂ is 4, and the difference between the numbers of turns of the two wound portions of the coil n₃ is 6.

With regard to the axial lengths of the wound portions, as described above, it is preferable to adjust the cross-sectional areas of the wires so that the difference between the axial lengths of the two wound portions is 5% or less of the axial length of one of the two wound portions. Specifically, the smaller the number of turns of a wound portion A compared with the number of turns of a wound portion B (the greater the difference between the numbers of turns), the further the cross-sectional area of a wire A is increased, and the further the cross-sectional area of a wire B is reduced.

That is to say, in the coil n₁, the cross-sectional area of a wire A₁>the cross-sectional area of a wire B₁;
in the coil n₂, the cross-sectional area of a wire A₂>the cross-sectional area of a wire B₂; and
in the coil n₃, the cross-sectional area of a wire A₃>the cross-sectional area of a wire B₃, and
the relationship in magnitude among the cross-sectional areas of the wires A is as follows: wire A₁<wire A₂<wire A₃; and
the relationship in magnitude among the cross-sectional areas of the wires B is as follows: wire B₁>wire B₂>wire B₃.

### Selection Step

In the selection step, based on the results of the maximum temperatures obtained in the temperature acquisition step, the cross-sectional areas of the respective wires 21w and 22w and the numbers of turns of the respective wound portions 21 and 22 are selected. In this selection, the cross-sectional areas of the wires and the numbers of turns of the wound portions when the higher maximum temperature of the maximum temperatures of the two wound portions obtained in the temperature acquisition step is the lowest are selected.

For example, with respect to the above-described three types of coils n₁, n₂, and n₃,
if the relationship in magnitude between the maximum temperatures of the coil n₁ is as follows: wound portion A₁<wound portion B₁;
the relationship in magnitude between the maximum temperatures of the coil n₂ is as follows: wound portion A₂<wound portion B₂; and
the relationship in magnitude between the maximum temperatures of the coil n₃ is as follows: wound portion A₃<wound portion B₃, and
the relationship in magnitude among the higher maximum temperatures is as follows: wound portion B₁<wound portion B₂<wound portion B₃,
the cross-sectional areas of the wires and the numbers of turns of the wound portions of the coil n₁ are selected as the cross-sectional areas of the wires 21w and 22w and the numbers of turns of the wound portions 21 and 22.

### Effects of the Design Method

With the above-described coil design method, a coil in which a pair of wound portions satisfies a specific relationship with respect to heat generation characteristics can be designed.

### Reactor

The above-described coil C can be used as the coil 2 of the reactor 1 shown in FIGS. 1 and 2. As described at the beginning of Embodiment 1, the reactor 1 includes the coil 2 and the magnetic core 3 on which the coil 2 is disposed. The coil 2 is constituted by the above-described coil C.

### Coil

The coil 2 includes the first wound portion 21 and the second wound portion 22, which have been described above. The two wound portions 21 and 22 are arranged side-by-side (in parallel) so that their axial directions are parallel to each other. This coil 2 is cooled by a cooling member (not shown). The cooling member includes a first cooling portion for cooling the first wound portion 21 and a second cooling portion for cooling the second wound portion 22, the second cooling portion having a higher cooling performance than the first cooling portion, the details of which will be described later. That is to say, the two wound portions 21 and 22 are arranged such that the first wound portion 21, in which the first wire 21w has the larger cross-sectional area and which has the smaller number of turns, is disposed on the first cooling portion side with the lower cooling performance, and the second wound portion 22, in which the second wire 22w has the smaller cross-sectional area and which has the larger number of turns, is disposed on the second cooling portion side with the higher cooling performance. Therefore, the first wound portion 21 and the second wound portion 22 are evenly cooled, and a difference in temperature between the two wound portions 21 and 22 can be made less likely to be generated.

### Magnetic Core

The magnetic core 3 includes a pair of inner core portions 31 that are disposed inside the respective wound portions 21 and 22 and a pair of outer core portions 32 that protrude (are exposed) from the coil 2 without the coil 2 being disposed thereon. The magnetic core 3 is formed into a ring-like shape in which the outer core portions 32 are arranged so as to sandwich the inner core portions 31 that are arranged spaced apart from each other, and end surfaces of the inner core portions 31 are in contact with inner end surfaces of the outer core portions 32. The inner core portions 31 and the outer core portions 32 together form a closed magnetic circuit when the coil 2 is energized. A known magnetic core can be used as this magnetic core 3.

### Inner Core Portions

Each of the inner core portions 31 may be composed of a stacked body in which a plurality of column-shaped core pieces and gap portions made of a material having a lower relative permeability than the core pieces are alternately stacked and arranged, or may be composed of a single column-shaped core piece having approximately the same length as the total length of the corresponding wound portion 21 or 22 in the axial direction without including a gap portion. The lengths of the pair of inner core portions 31 in the axial direction of the coil 2 are the same, and are substantially the same as the length of the coil 2 in the axial direction. It is preferable that the inner core portions 31 have shapes that match the inner peripheral shapes of the respective wound portions 21 and 22. Here, the shapes of the inner core portions 31 are rectangular parallelepiped shapes with approximately the same lengths as the total lengths of the respective wound portions 21 and 22 in their axial directions, and the corner portions of the rectangular parallelepiped shapes are rounded so as to conform to inner peripheral surfaces of the wound portions 21 and 22.

### Outer Core Portions

The outer core portions 32 are column-shaped bodies each having substantially dome-shaped upper and lower surfaces. The heights of the outer core portions 32 are greater than those of the inner core portions 31, and it is preferable that lower surfaces of the outer core portions 32 are flush with a lower surface of the coil 2. The heights of the outer core portions 32 refer to the lengths thereof in a vertical direction.

### Materials

A powder compact that is obtained by compression molding a soft magnetic powder, a composite material (molded and cured product) in which a soft magnetic powder and a resin are contained and the resin is hardened (cured), or the like can be used for the core pieces of the inner core portions 31 and the outer core portions 32.

Particles constituting the soft magnetic powder may be metal particles of an iron-group metal, such as pure iron, or a soft magnetic metal, such as an iron-based alloy (Fe—Si alloy, Fe—Ni alloy, etc.); coated particles in which an insulating coating composed of a phosphate or the like is provided on outer peripheries of metal particles; particles made of a nonmetal material such as ferrite; or the like.

The average particle diameter of the soft magnetic powder may be, for example, between 1 μm and 1,000 μm inclusive, and furthermore, between 10 μm and 500 μm inclusive. The average particle diameter can be obtained by acquiring a cross-sectional image under an SEM (scanning electron microscope) and analyzing the image using a piece of commercially-available image analysis software. At that time, an equivalent circle diameter is used as the particle diameter of a soft magnetic particle. To obtain the equivalent circle diameter, an outline of a particle is identified, and the diameter of a circle that has the same area as the area S of a region enclosed by the outline is determined as the equivalent circle diameter. That is to say, the equivalent circle diameter is expressed as follows: equivalent circle diameter=2×{area S of the inside of the outline/π}^{1/2}.

Examples of the resin in the composite material include thermosetting resins such as epoxy resins, phenolic resins, silicone resins, and urethane resins; thermoplastic resins such as polyphenylene sulfide (PPS) resins, polyamide (PA) resins (e.g., nylon 6, nylon 66, nylon 9T, etc.), liquid crystal polymers (LCPs), polyimide resins, and fluororesins; normal-temperature curing resins; and low-temperature curing resins. In addition, a BMC (bulk molding compound) manufactured by mixing calcium carbonate and glass fibers in unsaturated polyester, millable silicone rubber, millable urethane rubber, and the like can be used.

The amount of the resin contained in the composite material may be between 20 vol % and 70 vol % inclusive. The lower the resin content, that is, the higher the soft magnetic powder content, the more the saturation flux density and the heat dissipation properties can be expected to be improved. Therefore, the upper limit of the resin content can be set to be 50 vol % or less, and furthermore, 45 vol % or less, or 40 vol % or less. If the resin content is high to a certain extent, that is, if the soft magnetic powder content is low to a certain extent, when the raw material (raw material mixture) of the composite material is filled into a mold, the raw material has excellent fluidity and is easy to fill into the mold, and the manufacturability can be expected to be improved. Therefore, the lower limit of the resin content can be set to be 25 vol % or more, and furthermore, 30 vol % or more.

The above-described composite material can also contain a filler powder made of a non-magnetic material such as a ceramic, such as alumina or silica, in addition to the soft magnetic powder and the resin. In this case, the heat dissipation properties, for example, can be improved. The amount of the filler powder contained in the composite material may be between 0.2 mass % and 20 mass % inclusive, and furthermore, between 0.3 mass % and 15 mass % inclusive, or between 0.5 mass % and 10 mass % inclusive.

### Cooling Member

As described above, the cooling member includes the first cooling portion and the second cooling portion that have different cooling performances. Although the first cooling portion and the second cooling portion may be a plurality of members with different cooling performances, the first and second cooling portions may also be constituted by a single continuous cooling plate in which the cooling performance varies depending on the region because a flow path of a coolant is present only partially in the cooling plate or other reasons. The level of the cooling performance of the first cooling portion and the level of the cooling performance of the second cooling portion may differ to the extent that the first wound portion 21 and the second wound portion 22 can be evenly cooled. For example, it is conceivable that the ratio of the cooling performance (W) of the first cooling portion to the cooling performance (W) of the second cooling portion is about 1:2 to 1:20.

### Uses

The reactor 1 can be suitably used for a constituent component of various converters, such as in-vehicle converters (typically, DC-DC converters) installed in vehicles such as hybrid automobiles, plug-in hybrid automobiles, electric automobiles, and fuel-cell electric automobiles and converters for air conditioners, and power conversion devices.

### Effects of the Reactor

With the above-described reactor 1, since the reactor 1 includes the coil 2 having the first wound portion 21 that generates less heat and the second wound portion 22 that generates more heat, it is possible to reduce the loss that occurs in the case where the cooling performance of the cooling member for cooling the coil 2 is unbalanced.

### Test Example 1

With respect to a plurality of types of coils each including a pair of wound portions, the maximum temperatures of the respective wound portions under a predetermined current-flowing condition were obtained by performing simulations. In the simulations, the amounts of heat generated were calculated from the volume specific resistances, cross-sectional areas, and lengths of conductor portions as well as the currents flowing through the individual wound portions.

Five types of coils below were prepared, each type of coil including a wound portion A formed by helically winding a wire A formed of a coated rectangular wire and a wound portion B formed by helically winding a wire B formed of a coated rectangular wire made of the same material as the wire A.

The total number of turns of the two wound portions of each of these coils was set to be 2n (fixed).
Coil n₀: The number of turns of a wound portion A₀ was n, and the number of turns of a wound portion B₀ was n.
Coil n₁: The number of turns of a wound portion A₁ was n−1, and the number of turns of a wound portion B₁ was n+1.
Coil n₂: The number of turns of a wound portion A₂ was n−2, and the number of turns of a wound portion B₂ was n+2.
Coil n₃: The number of turns of a wound portion A₃ was n−3, and the number of turns of a wound portion B₃ was n+3.
Coil n₄: The number of turns of a wound portion A₄ was n−4, and the number of turns of a wound portion B₄ was n+4.

In the coil n₀, the number of turns of the wound portion A₀=the number of turns of the wound portion B₀, and the difference between the numbers of turns of the two wound portions was 0. In the coil n₁, the number of turns of the wound portion A₁<the number of turns of the wound portion B₁, and the difference between the numbers of turns of the two wound portions was 2. Similarly, the difference between the numbers of turns of the two wound portions of the coil n₂ was 4, the difference between the numbers of turns of the two wound portions of the coil n₃ was 6, and the difference between the numbers of turns of the two wound portions of the coil n₄ was 8.

Here, the cross-sectional areas (thicknesses) of the wires A and B were adjusted so that the difference between the axial lengths of the wound portions A and B was 5% or less of the axial length of the wound portion A. The widths of the wires A and B were the same. Specifically, the smaller the number of turns of the wound portion A compared with the number of turns of the wound portion B (the greater the difference between the numbers of turns), the further the cross-sectional area (thickness) of the wire A was increased, and the further the cross-sectional area (thickness) of the wire B was reduced.

That is to say, in the coil n₀, the cross-sectional area of a wire A₀=the cross-sectional area of a wire B₀;
in the coil n₁, the cross-sectional area of a wire A₁>the cross-sectional area of a wire B₁;
in the coil n₂, the cross-sectional area of a wire A₂>the cross-sectional area of a wire B₂;
in the coil n₃, the cross-sectional area of a wire A₃>the cross-sectional area of a wire B₃; and
in the coil n₄, the cross-sectional area of a wire A₄>the cross-sectional area of a wire B₄, and
the relationship in magnitude among the cross-sectional areas of the wires A was as follows: wire A₀<wire A₁<wire A₂<wire A₃<wire A₄; and
the relationship in magnitude among the cross-sectional areas of the wires B was as follows: wire B₀>wire B₁>wire B₂>wire B₃>wire B₄.

Reactors were constructed by attaching the wound portions of each coil to inner core portions of a magnetic core, and the maximum temperatures of the wound portions were obtained by letting current flow through each coil. The following two current-flowing conditions were employed: a continuous current-flowing condition in which a current of “x” ampere (A) continuously flows through the coil and a transient-current current-flowing condition in which a current of “y” ampere (A) (x<y) flows through the coil for “z” seconds (sec). Here, a situation was assumed in which the cooling performance for the wound portion A and the cooling performance for the wound portion B were different from each other. Specifically, the cooling performance of a cooling portion B for cooling the wound portion B was higher than the cooling performance of a cooling portion A for cooling the wound portion A.

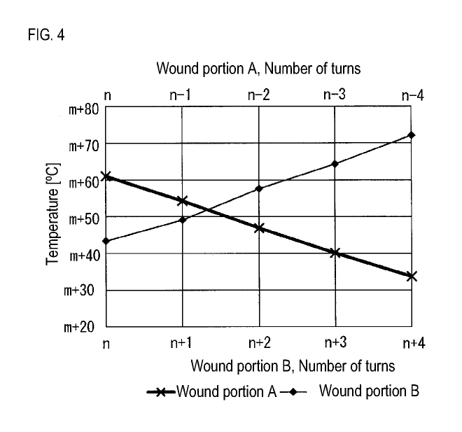

FIG. 3 shows the results of the maximum temperatures of the respective wound portions under the continuous current-flowing condition, and FIG. 4 shows the results of the maximum temperatures of the respective wound portions under the transient-current current-flowing condition. In the graphs shown in FIGS. 3 and 4, the horizontal axis on the upper side indicates the number of turns of the wound portion A, the horizontal axis on the lower side indicates the number of turns of the wound portion B, and the vertical axis indicates the temperature (° C.). The temperatures on the vertical axis are expressed relative to “m (° C.)” and indicate how much higher than m (° C.). In FIGS. 3 and 4, the “cross” marks indicate the results with respect to the wound portion A, and the “solid square” marks indicate the results with respect to the wound portion B.

As shown in FIGS. 3 and 4, it was found that even though the cooling performance of the cooling portion B for cooling the wound portion B was higher than the cooling performance of the cooling portion A for cooling the wound portion A, regardless of whether the current-flowing condition was the continuous current-flowing condition or the transient-current current-flowing condition, the relationship in magnitude between the maximum temperature of the wound portion A and the maximum temperature of the wound portion B was inverted at specific numbers of turns of the respective wound portions, though there were variations in the specific numbers of turns.

Specifically, it was found that, under the above-described continuous current-flowing condition, as shown in FIG. 3, the relationship in magnitude between the maximum temperature of the wound portion A and the maximum temperature of the wound portion B was inverted between n−2 and n−3 with respect to the number of turns of the wound portion A and between n+2 and n+3 with respect to the number of turns of the wound portion B. In the cases where the number of turns of the wound portion A was n to n−2, and the number of turns of the wound portion B was n to n+2, the maximum temperature of the wound portion A was higher than the maximum temperature of the wound portion B. In the cases where the number of turns of the wound portion A was n−3 to n−4, and the number of turns of the wound portion B was n+3 to n+4, the maximum temperature of the wound portion B was higher than the maximum temperature of the wound portion A.

As shown in FIG. 3, under the above-described continuous current-flowing condition, the coils had the following relationships in magnitude between the maximum temperatures of the two wound portions.
The relationship in magnitude between the maximum temperatures of the coil n₀: wound portion A₀>wound portion B₀
The relationship in magnitude between the maximum temperatures of the coil n₁: wound portion A₁>wound portion B₁
The relationship in magnitude between the maximum temperatures of the coil n₂: wound portion A₂>wound portion B₂
The relationship in magnitude between the maximum temperatures of the coil n₃: wound portion A₃<wound portion B₃
The relationship in magnitude between the maximum temperatures of the coil n₄: wound portion A₄<wound portion B₄

The relationship in magnitude among the higher maximum temperatures was as follows: wound portion B₃<wound portion B₄<wound portion A₂<wound portion A₁<wound portion A₀. It can be seen from FIG. 3 that the higher maximum temperature of the maximum temperatures of the two wound portions of the coil n₃ was the lowest. That is to say, it can be seen that, under the above-described continuous current-flowing condition, it is preferable to select the cross-sectional areas of the wires and the numbers of turns of the wound portions of the coil n₃ as the cross-sectional areas of the wires and the numbers of turns of the wound portions.

On the other hand, it was found that, under the above-described transient-current current-flowing condition, as shown in FIG. 4, the relationship in magnitude between the maximum temperature of the wound portion A and the maximum temperature of the wound portion B was inverted between n−1 and n−2 with respect to the number of turns of the wound portion A and between n+1 and n+2 with respect to the number of turns of the wound portion B. In the cases where the number of turns of the wound portion A was n to n−1, and the number of turns of the wound portion B was n to n+1, the maximum temperature of the wound portion A was higher than the maximum temperature of the wound portion B. In the cases where the number of turns of the wound portion A was n−2 to n−4, and the number of turns of the wound portion B was n+2 to n+4, the maximum temperature of the wound portion B was higher than the maximum temperature of the wound portion A.

As shown in FIG. 4, under the above-described transient-current current-flowing condition, the coils had the following relationship in magnitude between the maximum temperatures of the two wound portions.
The relationship in magnitude between the maximum temperatures of the coil n₀: wound portion A₀>wound portion B₀
The relationship in magnitude between the maximum temperatures of the coil n₁: wound portion A₁>wound portion B₁
The relationship in magnitude between the maximum temperatures of the coil n₂: wound portion A₂<wound portion B₂
The relationship in magnitude between the maximum temperatures of the coil n₃: wound portion A₃<wound portion B₃
The relationship in magnitude between the maximum temperatures of the coil n₄: wound portion A₄<wound portion B₄

The relationship in magnitude among the higher maximum temperatures was as follows: wound portion A₁<wound portion B₂<wound portion A₀<wound portion B₃<wound portion B₄. It can be seen from FIG. 4 that the higher maximum temperature of the maximum temperatures of the two wound portions of the coil n₁ was the lowest. That is to say, it can be seen that, under the above-described transient-current current-flowing condition, it is preferable to select the cross-sectional areas of the wires and the numbers of turns of the wound portions of the coil n₁ as the cross-sectional areas of the wires and the numbers of turns of the wound portions.

The present disclosure is not limited to the foregoing examples, but rather is defined by the claims, and all changes that come within the meaning and range of equivalency of the claims are intended to be embraced therein.

1. A coil comprising:
a first wound portion that is formed by helically winding a first wire; and
a second wound portion that is formed by helically winding a second wire electrically connected to the first wound portion and has an axis that is parallel to an axis of the first wound portion,
wherein the first wound portion and the second wound portion are arranged side-by-side,
the first wire has a larger cross-sectional area than the second wire, and
the first wound portion has a smaller number of turns than the second wound portion.

2. The coil according to claim 1, wherein the difference between a length of the first wound portion in an axial direction thereof and a length of the second wound portion in an axial direction thereof is 5% or less of the length of the first wound portion in the axial direction.

3. The coil according to claim 1, wherein the difference between the number of turns of the first wound portion and the number of turns of the second wound portion is 10 or less.

4. The coil according to claim 1, wherein conductor wires of the first wire and the second wire are rectangular wires,
the first wire and the second wire have the same width, and
the first wire and the second wire have different thicknesses.

5. A reactor comprising:
a coil; and
a magnetic core on which the coil is disposed,
wherein the coil is the coil according to claim 1.

6. A coil design method comprising:
a temperature acquisition step of obtaining, under a predetermined current-flowing condition, the maximum temperatures of wound portions of coils, the coils each including a first wound portion that is formed by helically winding a first wire and a second wound portion that is formed by helically winding a second wire electrically connected to the first wound portion and has an axis that is parallel to an axis of the first wound portion, the wires of the coils having different cross-sectional areas and the wound portions of the coils having different numbers of turns, with a total number of turns of each coil being fixed; and
a selection step of selecting the cross-sectional areas of the respective wires and the numbers of turns of the respective wound portions when a higher maximum temperature of the maximum temperatures of the two wound portions is the lowest.

7. The coil according to claim 2, wherein conductor wires of the first wire and the second wire are rectangular wires,
the first wire and the second wire have the same width, and
the first wire and the second wire have different thicknesses.

8. The coil according to claim 3, wherein conductor wires of the first wire and the second wire are rectangular wires,
the first wire and the second wire have the same width, and
the first wire and the second wire have different thicknesses.

9. A reactor comprising:
a coil; and
a magnetic core on which the coil is disposed,
wherein the coil is the coil according to claim 2.

10. A reactor comprising:
a coil; and
a magnetic core on which the coil is disposed,
wherein the coil is the coil according to claim 3.

11. A reactor comprising:
a coil; and
a magnetic core on which the coil is disposed,
wherein the coil is the coil according to claim 4.
